(19) United States
(12) Patent Application Publication
(10) Pub. No.: US 2002/0045541 A1
(43) Pub. Date: Apr. 18, 2002

(54) Ceramic carrier and ceramic catalyst body

(76) Inventors: Kazuhiko Koike, Nishio-shi (JP); Tomohiko Nakanishi, Nishio-shi (JP); Masakazu Tanaka, Okazaki-City (JP); Tosiharu Kondo, Toyoake-City (JP)

Correspondence Address: NIXON & VANDERHYE P.C., 8th Floor, 1100 North Glebe Road, Arlington, VA, 22201, US

(21) Appl. No.: 09/966,723

(22) Filed: Oct. 1, 2001

(30) Foreign Application Priority Data
Oct. 2, 2000 (JP) 2000-301787
Aug. 27, 2001 (JP) 2001-255611

(51) Int. Cl. B01J 21/16

(52) U.S. Cl. 502/251; 502/527.18; 502/252

(57) ABSTRACT

It is an object of the present invention to provide a ceramic catalyst body with a better catalyst performance by using a ceramic carrier capable of directly supporting a catalyst component.

The ceramic carrier of the present invention has a multitude of pores or element capable of directly supporting the catalyst on the surface of the substrate ceramic and a multitude of cells disposed substantially parallel to each other with the inside thereof serving as gas flow passage, and the cell wall has an irregular surface. Since the irregular surface of the cell wall results in larger surface area, an improvement in the conversion performance due to increased quantity of catalyst supported can be achieved or the distance between the catalyst particles can be made larger to thereby prevent deterioration. The irregular surface also disturbs the gas flow near the catalyst so that the probability of making contact with the catalyst increases thus resulting in improved conversion performance.

### BACKGROUND OF THE INVENTION

1. Field of the Invention

The present invention relates to a ceramic catalyst used in a catalyst for converting an exhaust gas of an automobile engine or the like.

2. Description of the Related Art

A catalyst that has been used for the conversion of exhaust gas consists of a carrier comprising a cordierite honeycomb structure having high resistance against thermal shock coated on the surface thereof with γ-alumina and provided with a noble metal catalyst supported thereon. The coating layer is formed because the specific surface area of the cordierite is too small to support a required amount of catalyst component. Thus the specific surface area of the carrier is increased by means of a material which has a large specific surface area such as γ-alumina.

When the surfaces of the carrier cell walls are coated with γ-alumina, however, heat capacity of the carrier increases due to the increase in the mass. Recently investigations have been conducted for a means to decrease the heat capacity by making the cell wall thinner, in order to activate the catalyst earlier. However, the effect of this attempt is reduced by the formation of the coating layer, thus necessitating an improvement. There have also been such problems that a decrease in the opening area of the cell increases the pressure loss, and the coefficient of thermal expansion of the carrier becomes larger than that of a carrier which is made solely of cordierite.

Although methods to increase the specific surface area of the cordierite itself have been investigated (for example, Japanese Examined Patent Publication No. 5-503338), such approaches have not been practical because a pickling process or a heat treatment causes the destruction of the crystal lattice of cordierite, thus resulting in lower mechanical strength.

### SUMMARY OF THE INVENTION

An object of the present invention is to improve the ceramic carrier capable of directly supporting the catalyst component described above, thereby to provide a ceramic carrier having improved catalyst performance when loaded with catalyst supported thereon.

According to a first aspect of the invention, a ceramic carrier capable of supporting the catalyst directly on the surface of substrate ceramic is provided, which has a multitude of cells arranged substantially in parallel to each other with the inside thereof serving as the passage of gas flow and the cell wall has irregular surface.

When the cell wall has irregular surface, the surface area increases and effects can be obtained such as an improved conversion performance due to increased quantity of catalyst which can be supported and prevention of deterioration by increasing the space between catalyst particles. The surface irregularity also has an effect such that the gas flow near the catalyst is disturbed and the probability of making contact with the catalyst increases, thus improving the conversion performance.

The cell wall having irregular surface may specifically be the cell wall with corrugated surface or roughened surface. Pitch of the corrugated surface is typically set to be not larger than the carrier length. Preferably the pitch of the corrugated surface is 20 mm or less, and more preferably 5 mm or less. Amplitude of the corrugation is set to ½ of the cell pitch or less, and preferably in a range from ⅓ to ½ of the cell pitch.

An effect similar to that of the surface irregularity can be achieved also by providing the cell wall with a plurality of projections jutting from the surface inward. In this case, cross sectional area of the projection is typically set to be not larger than a half the area of cell opening. Preferably, cross sectional area of the projection is in a range from 1/20 to ⅓ of the area of the cell opening.

A ceramic carrier of a second aspect of the invention is a ceramic carrier capable of supporting the catalyst directly on the surface of substrate ceramic, which has a multitude of cells arranged substantially in parallel to each other with the inside thereof serving as the passage of gas flow, while the passage of gas flow is not straight.

By forming a passage for gas flow which is not straight, in the cell, the effect of disturbing the gas flow is obtained and the probability of making contact with the catalyst is increased, thus improving the conversion performance.

Specifically, the passage for gas flow can be in a configuration which is not straight by disposing the multitude of cells skewed with respect to the flow direction. In this case, the radius of curvature of the carrier may be set to 10 m or larger. Preferably the radius of curvature of the carrier is set to 1 m or larger, and more preferably in a range from 200 to 500 mm.

Alternatively, as in the case of the ceramic carrier according to a third aspect of the invention, the passage of gas flow may be curved by disposing the multitude of cells along a spiral. Specifically, the spiral is designed to turn 0.1 degrees or more per 1 m along the flow passage. Preferably, the spiral is designed to make one full turn or more per 1 m along the flow passage, and more preferably two to four turns per 1 m along the flow passage.

A ceramic carrier of a fourth aspect of the invention is a ceramic carrier capable of supporting the catalyst directly on the surface of substrate ceramic, which has a multitude of cells arranged substantially in parallel to each other with the inside thereof serving as the passage of gas flow and the cells have polygonal, L-shaped, convex, cross, S-shaped or dumbbell configuration or a shape which combines some of the former.

Given a same cross sectional area, surface area of the cell wall increases as the cell shape departs from circle. Thus the surface area can be increased by forming the cell having a cross section of shape other than circle or combining various shapes. A complicated shape of the cell cross section also causes more disturbance in the gas flow, thereby improving the conversion performance.

A ceramic carrier of a fifth aspect of the invention is a ceramic carrier capable of supporting the catalyst directly on the surface of substrate ceramic, which has a multitude of cells arranged substantially in parallel to each other with the inside thereof serving as the passage of gas flow, wherein the multitude of cells have a multitude of through holes in the cell wall.

Providing the multitude of through holes in the cell wall causes the exhaust gas to flow from one cell to the adjacent cell, thus causing more disturbance in the gas flow, thereby improving the conversion performance.

Length of the through hole along the flow passage is typically not larger than five times the cell pitch. Preferably, length of the through hole along the flow passage is not larger than the cell pitch. Width of the through hole in the direction perpendicular to the flow passage is preferably smaller than the cell pitch.

A ceramic carrier of a sixth aspect of the invention is a ceramic carrier capable of supporting the catalyst directly on the surface of substrate ceramic, wherein the substrate ceramic has a porosity of 5% or higher.

In the ceramic carrier described above which can directly support the catalyst, the exhaust gas is less likely to stay on the cell wall surface in comparison to the ceramic carrier of the prior art which has a coating layer formed on the surface. Therefore the present invention sets the porosity of the substrate ceramic to 5% or higher. This causes the gas flow to be disturbed by the voids which open in the cell wall surface, and therefore the probability of making contact with the catalyst is increased, thus improving the conversion performance.

Preferably, the porosity of the substrate ceramic is set to 10% or higher. The porosity of the substrate ceramic is more preferably set to 30% or higher.

A ceramic carrier of a seventh aspect of the invention is a ceramic carrier capable of supporting the catalyst directly on the surface of substrate ceramic, which has a multitude of cells arranged substantially in parallel to each other with the inside thereof serving as the passage of gas flow, wherein density of the cells is 50/in² or higher.

When the density of cells is increased to 50/in² or higher, the surface area increases resulting in a larger area whereon the catalyst can be supported. That is, since the quantity of catalyst can be increased while the catalyst particle size and the distance between the catalyst particles remain constant, conversion performance is improved. In case the quantity of catalyst supported is kept constant, the distance between the catalyst particles can be made larger and deterioration due to aggregation of the catalyst can be prevented.

Preferably density of the cells is set to 100/in² or higher. More preferably density of the cells is set to 400/in² or higher.

A ceramic carrier of an eighth aspect of the invention has a multitude of cells arranged substantially in parallel to each other with the inside thereof serving as the passage for gas flow, wherein a plurality of ceramic carriers which are capable of supporting the catalyst directly on the surface of substrate ceramic are disposed in series in the direction of the gas flow, so that the cell walls of the plurality of ceramic carriers are discontinuous at the joints.

With the constitution described above, since the wall of the flow passage becomes discontinuous at the joints of the plurality of ceramic carriers, the gas flow is disturbed and the conversion performance is improved.

According to a ninth aspect of the invention, such a carrier can be used as one or more of the elements which constitute the ceramic substrate is substituted with an element other than the constituent element, and the carrier is made capable of supporting the catalyst component directly on the substituting element.

In this case, the catalyst component is preferably supported on the substituting element through chemical bonding. Chemical bonding of the catalyst component improves the retention of the catalyst and mitigates the deterioration resulting from a long period of use as the catalyst component is evenly distributed over the carrier with little tendency to aggregate.

For the substituting element, one or more elements having d or f orbits in the electron orbits thereof can be used. Elements which have d or f orbits in the electron orbits thereof have higher tendency to bond with the catalyst component, and are therefore preferable.

AS the ceramic carrier described above, a carrier may be used that has a multitude of pores capable of directly supporting the catalyst on the surface of the substrate ceramic so that the catalyst component can be supported directly in the pores.

The pores described above specifically comprise at least one kind selected from among a group consisting of defects in the ceramic crystal lattice, microscopic cracks in the ceramic surface and missing defects of the elements which constitute the ceramic.

The microscopic cracks are preferably 100 nm or smaller in width in order to ensure mechanical strength of the carrier.

In order to make it possible to support the catalyst component, the pores have diameter or width preferably 1000 times the diameter of the catalyst ion to be supported or smaller. At this time, a quantity of catalyst component comparable to that in the prior art can be supported when the density of pores is 1×10¹¹/L or higher.

For the substrate ceramic described above, a ceramic which includes cordierite as the main component is used, and the pores may be defects formed by substituting a part of the constituent elements of the cordierite with metal element having different value of valence. Cordierite has high resistance against thermal shock and is therefore suitable for the catalyst body to convert the automobile exhaust gas.

The defects described above are at least one kind of an oxygen defect or a lattice defect. A quantity of catalyst component comparable to that in the prior art can be supported when the density of cordierite crystal which includes at least one defect in a unit crystal lattice of cordierite is set to 4×10⁻⁶% or higher.

A tenth aspect of the present invention provides a ceramic catalyst body which directly supports a catalyst without forming a coating layer on the ceramic carrier, so as to effectively demonstrate the catalyst performance and high conversion performance.

### BRIEF DESCRIPTION OF THE DRAWINGS

FIG. 1 shows the relationship between a porosity and 50% conversion temperature.

FIG. 2 shows the relationship between density of cells and 50% conversion temperature.

FIG. 3 shows an example of a cell wall shape having surface irregularity, schematically showing the cell wall having corrugated surface.

FIGS. 4(a) and (b) show examples of ceramic carriers having gas flow passages formed to be not straight, FIG. 4(a) schematically showing the ceramic carrier which is curved as a whole, and FIG. 4(b) schematically showing the ceramic carrier having curved cells.

FIGS. 5(a) to 5(1) are sectional views of cells showing examples of sectional configurations of the cells.

FIGS. 6(a) to 6(f) are sectional views of cells showing examples in which projections are formed on the cell wall.

FIG. 7 is a partially enlarged view of the ceramic carrier having through holes formed in the cell wall.

FIG. 8 shows an example of disposing a plurality of ceramic carriers in series.

FIG. 9 shows the setup for measuring pressure loss.

### DESCRIPTION OF THE PREFERRED EMBODIMENTS

Now the invention will be described in detail below. According to the invention, a ceramic carrier capable of directly supporting the catalyst component on the surface of the substrate ceramic is used, and the ceramic catalyst body is made by having a catalyst supported on the ceramic carrier. The ceramic carrier is based on the substrate ceramic made preferably from cordierite which has theoretical composition of 2MgO•2Al₂O₃•5SiO₂ as the main component. Instead of cordierite, other ceramic materials such as alumina, mullite, spinel, aluminum titanate, titania, silicon carbide and zirconium phosphate may also be used. The ceramic carrier has a configuration such as a honeycomb structure which has a multitude of substantially parallel cells or porous foamed configuration, which makes it possible to make maximum use of the characteristics of the substrate ceramic that can directly support the catalyst while increasing the surface area.

The ceramic carrier has a multitude of pores or elements capable of directly supporting the catalyst component on the surface of the substrate ceramic, so that the catalyst component can be supported directly in the pores or on the elements. An element which is capable of directly supporting the catalyst component is an element introduced by substituting one or more elements among the constituent elements of the substrate ceramic with an element other than the constituent element, which will be described in detail later.

First, the ceramic carrier which has a multitude of pores that are capable of directly supporting the catalyst component provided on the surface of the ceramic substrate will be described below. Specifically, the pores comprise at least one kind selected from among a group consisting of defects in the ceramic crystal lattice (oxygen defect or lattice defect), microscopic cracks in the ceramic surface and missing defects of the elements which constitute the ceramic. It suffices that at least one kind of these pores be formed in the ceramic carrier, while two or more of kinds thereof may also be formed in combination. In order to make it possible to support the catalyst component without forming a coating layer of a material which has large specific surface area such as γ-alumina, it is desired that diameter or width of the pores is not larger than 1000 times (100 nm) the diameter of the ions of the catalyst component to be supported therein (typically about 0.1 nm), preferably in a range from 1 to 1000 times (0.1 to 100 nm). Depth of the pore is preferably a half the diameter of the catalyst ion or larger, typically 0.05 nm or larger. In order to support the catalyst component in a quantity comparable to that of the prior art (1.5 g/L) with the pores of the dimensions described above, density of the pores is 1×10¹¹/L or higher, preferably 1×10¹⁶/L or higher and more preferably 1×10¹⁷/L or higher.

Among the pores formed in the ceramic surface, the defects in the crystal lattice are classified into oxygen defect and lattice defect (metal vacancy and lattice strain). Oxygen defect is caused by the lack of oxygen atoms which constitute the crystal lattice of the ceramic, and allows it to support the catalyst component in the vacancy left by the missing oxygen. Lattice defect is caused by trapping of more oxygen atoms than necessary to form the ceramic crystal lattice, and allows it to support the catalyst component in the pores formed by the strains in the crystal lattice or the metal vacancies.

Oxygen defects may be formed in the crystal lattice as described in Japanese Patent Application No. 2000-104994, in a process after forming and degreasing, by sintering a material for cordierite containing an Si source, an Al source and an Mg source while either \mathring{1} decreasing the pressure of the sintering atmosphere or making it a reducing atmosphere; \mathring{2} sintering in a low-oxygen concentration atmosphere using a compound which does not include oxygen for at least a part of the raw material so as create oxygen deficiency in the sintering atmosphere or in the starting material; or \mathring{3} substituting at least one of the constituent elements of the ceramic except for oxygen with an element having a value of valence lower than that of the substituted element. In the case of cordierite, since the constituent elements have positive valence such as Si (4+), Al (3+) and Mg (2+), substituting these elements with an element of lower value of valence leads to deficiency of positive charge which corresponds to the difference from the substituting element in the value of valence and to the amount of substitution. Thus O (2−) having negative charge is released so as to maintain the electrical neutrality of the crystal lattice, thereby forming the oxygen deficiency.

Lattice defects can be formed by \mathring{4} substituting a part of the constituent elements of the ceramic except for oxygen with an element which has a value of valence higher than that of the substituted element. When at least part of Si, Al and Mg which are constituent elements of the cordierite is substituted with an element having a value of valence higher than that of the substituted element, a positive charge which corresponds to the difference from the substituting element in the value of valence and to the amount of substitution becomes redundant, so that the required amount of O (2−) having negative charge is taken into the lattice in order to maintain the electrical neutrality of the crystal lattice. The oxygen atoms which have been taken into the crystal make an obstacle for the cordierite unit crystal lattice to form an orderly structure, thus resulting in the lattice strain. Or, alternatively, part of Si, Al and Mg is released to maintain the electrical neutrality of the crystal lattice, thereby forming vacancies. In this case, sintering is carried out in an air atmosphere so as to supply sufficient amount of oxygen. Since the sizes of these defects are believed to be on the order of several angstroms or smaller, they are not accounted for in the specific surface area measured by ordinary methods such as BET method which uses nitrogen molecules.

Number of oxygen defects and lattice defects is related to the amount of oxygen included in the cordierite honeycomb structure, and it is possible to support the required quantity of catalyst component by controlling the amount of oxygen below 47% by weight (oxygen defect) or over 48% by weight (lattice defect). When the amount of oxygen is decreased to below 47% by weight due to the formation of oxygen defects, the number of oxygen atoms included in the cordierite unit crystal lattice becomes less than 17.2, and the lattice constant for bₒ axis of the cordierite crystal becomes smaller than 16.99. When the amount of oxygen is increased above 48% by weight due to the formation of the lattice defects, the number of oxygen atoms included in the cordierite unit crystal lattice becomes larger than 17.6, and the lattice constant for bₒ axis of the cordierite crystal becomes larger or smaller than 16.99.

Predetermined number of or more pores can be formed in the ceramic carrier, when the density of cordierite crystal containing at least one defect of at least one kind, oxygen defect or lattice defect, in a unit crystal lattice of cordierite is set to 4×10⁻⁶% or higher, and preferably 4×10⁻⁵ % or higher, or alternatively, 4×10⁻⁶ or more, preferably 4×10⁻⁷ or more defects of at least one kind, oxygen defect or lattice defect, are included in a unit crystal lattice of the cordierite honeycomb structure.

Among the pores which can support the catalyst, microscopic cracks in the ceramic surface are formed in multitude at least in one of amorphous phase and crystal phase by applying thermal shock or shock wave to the cordierite honeycomb structure. The cracks are required to be small, about 100 nm or less, and preferably 10 nm or smaller in width, in order to ensure mechanical strength of the honeycomb structure.

Thermal shock can be applied by quenching the cordierite honeycomb structure which has been heated. The time of applying the thermal shock may be after the time when the cordierite crystal phase or amorphous phase has been formed in the cordierite honeycomb structure. Thermal shock may be applied either by forming, degreasing and sintering a material for cordierite containing an Si source, an Al source and an Mg source in an ordinary process, heating the cordierite honeycomb structure thus formed to a predetermined temperature again and then quenching it, or by quenching from a predetermined temperature during the transition from sintering to cooling. Cracks due to thermal shock can be generated when the temperature difference (thermal shock temperature difference) is about 80° C. or larger between the time of heating and after quenching, while the crack size increases as the thermal shock temperature difference increases. The thermal shock temperature difference should be kept within about 900° C. as large cracks make it difficult to maintain the shape of the honeycomb structure.

In the cordierite honeycomb structure, the amorphous phase exists in the form of layers formed around the crystal phase. When thermal shock is applied by heating and then quenching the cordierite honeycomb structure, as there is a difference in the coefficient of thermal expansion between the amorphous phase and the crystal phase, thermal stress corresponding to the difference in the coefficient of thermal expansion and to the thermal shock temperature difference is generated around the interface between the amorphous phase and the crystal phase. When the amorphous phase or the crystal phase is unable to endure the thermal stress, microscopic cracks are generated. The number of microscopic cracks generated can be controlled by the amount of amorphous phase. When a trace component (alkali metal element, alkali earth metal element, etc.) included in the raw material which is believed to contribute to the formation of the amorphous phase is added in a quantity larger than normal, the number of cracks generated is increased. Shock waves of ultrasonic or vibration can also be used instead of thermal shock. When a weak portion of the cordierite honeycomb structure is unable to endure the shock wave, microscopic cracks are generated. The number of cracks generated can be controlled by the energy of the shock wave.

In the pores which can support the catalyst, missing defects of the elements which constitute the ceramic are formed through elution of the constituent element of the cordierite or impurity by a liquid phase method and, for example, the defects are formed when metal elements such as Mg and Al included in the cordierite crystal, alkali metal or alkali earth metal included in the amorphous phase or the amorphous phase itself dissolves into water of high temperature and high pressure, into a super-critical fluid or into a solution such as an alkali solution. Missing defects of these elements form pores which support the catalyst. The defects may also be formed chemically or physically by a gas phase method. A chemical method includes dry etching and a physical method includes sputter etching, in which case the number of pores can be controlled by regulating the duration of etching or the amount of energy supplied.

A carrier having a multitude of particles of elements which are capable of supporting the catalyst component directly on the surface of the substrate ceramic being provided by the substitution of elements will be described below. In this case, constituent elements of the ceramic (for example Si, Al and Mg in the case of cordierite) are substituted with such an element that has greater force for bonding with the catalyst than the constituent element to be substituted and is capable of supporting the catalyst component by chemical bonding. Specifically, the substituting elements may be those which are different from the constituent elements and have d or f orbits in the electron orbits thereof, and preferably have an empty orbit in the d or f orbits or have two or more oxidation states. An element which has empty orbit in the d or f orbit has energy level near that of the catalyst being supported, which means higher tendency to exchange electrons and bond with the catalyst component. An element which has two or more oxidation states also has higher tendency to exchange electrons and provides the same effect.

Elements which have empty orbit in the d or f orbit include W, Ti, V, Cr, Mn, Fe, Co, Ni, Zr, Mo, Ru, Rh, Ce, Ir, Pt, etc. of which one or more can be used. Among these, W, Ti, V, Cr, Mn, Fe, Co, Mo, Ru, Rh, Ce, Ir and Pt are elements which have two or more oxidation states. Besides these, elements which have two or more oxidation states include Cu, Ga, Ge, Se, Pd, Ag, Au, etc.

When substituting the constituent element of the ceramic with these substituting elements, a method may be employed where the substituting element is added to the ceramic material and mixed, as described above. However, a method may also be employed where the material including the constituent element to be substituted is reduced by the amount corresponding to the amount of substitution, followed by mixing, forming and drying, before being immersed in a solution containing the substituting element thereby to be impregnated therewith. The material is taken out of the solution, dried and then subjected to degreasing and sintering in an air atmosphere. This method of impregnating the preform is preferably employed, since the substituting element can be deposited sufficiently on the surface of the preform and, as a result, the element is substituted on the surface during sintering, thus making it easier for a solid solution to form.

The amount of substituting element is set within a range from 0.01% to 50%, and preferably in a range from 5 to 20% of the substituted constituent element in terms of the number of atoms. In case the substituting element has a value of valence different from that of the constituent element of the substrate ceramic, lattice defects or oxygen defects are generated at the same time depending on the difference in the valence, as described above. But the defects can be prevented from occurring by using a plurality of substituting elements and setting the sum of oxidation numbers of the substituting elements equal to the sum of oxidation numbers of the substituted constituent elements. Thus the catalyst component may be supported only by bonding with the substituting elements while keeping the valence constant as a whole.

The ceramic catalyst body comprising a ceramic carrier which has a multitude of pores on the surface thereof, with a catalyst component supported directly on the ceramic carrier, is preferably used in catalyst for converting an engine exhaust gas or the like. A noble metal catalyst such as Pt, Pd, Ir or Rh is usually used as the catalyst metal. CeO₂ or the like can be used as a promoter, as a matter of course.

The ceramic carrier may be immersed in a solution containing a catalyst metal compound dissolved therein thereby to support the catalyst component. Although the solvent may be water, a solvent having smaller surface tension, for example alcohol solvent such as ethanol, is more preferably used, since the defects or cracks which constitute the pores formed in the ceramic carrier have microscopic size. While a solvent which has large surface tension such as water cannot easily infiltrate into the pores and is unable to fully make use of the pores, use of the solvent having smaller surface tension which can infiltrate into microscopic pores makes it possible to support 0.5 g/L or more catalyst component by making full use of the pores.

The ceramic carrier immersed in the catalyst solution is then dried and sintered at a temperature from 500 to 900° C. This makes a ceramic catalyst body having the catalyst component supported in the pores formed in the cell wall surface of the carrier or on the element which makes contact with the exhaust gas. In the case of the ceramic catalysts of the prior art which utilize a coating layer made of γ-alumina or the like, some of the catalyst component may exist at such portions that cannot be reached by the exhaust gas. In the case of the ceramic catalysts of the present invention, by contrast, the catalyst component is concentrated and supported on the cell wall surface which has high probability of making contact with the exhaust gas, thus making it possible to make full use of the catalyst for converting the exhaust gas. Also, because the catalyst is deposited by using a solution, the catalyst can be made in fine particles. Moreover, since gas can easily enter the pores which can be infiltrated by the solution, the catalyst component can be supported efficiently only in portions which make contact with the exhaust gas.

In the ceramic carrier which can directly support the catalyst, however, the exhaust gas is less likely to stay on the cell wall surface than in the case of the ceramic carrier of the prior art which has a coating layer formed on the surface. In order to overcome this drawback, it is desirable to set the porosity of the substrate ceramic to 5% or higher, preferably 10% or higher, more preferably 30% or higher, and further more preferably 40% or higher. Since the porosity is determined by measuring the pores which open in the cell wall surface, a larger value of this figure means more pores existing in the cell wall surface which contacts with exhaust gas and causing disturbance in the flow of exhaust gas, thus generating more turbulent flow along the cell wall surface. As a result, the probability of the catalyst supported on the cell wall surface making contact with the catalyst is increased, thus improving the conversion performance. In order to achieve a desired porosity, methods may be employed, such as controlling the compositions of carrier material and additive and the forming and sintering conditions, adding a proper quantity of carbon particles or the like which are evaporated at the sintering temperature, or applying post-processing, in order to form voids in the surface after sintering.

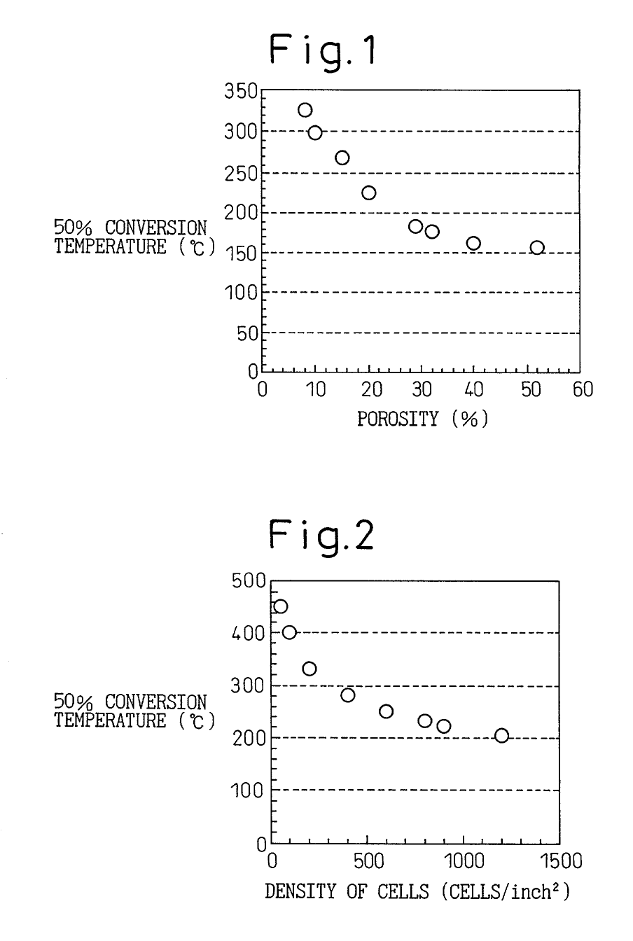

FIG. 1 shows the result of measuring the conversion performance of the ceramic catalysts body made by depositing the catalyst component under the same conditions on ceramic carriers having different porosity ranging from about 5 to 50%. The ceramic carriers were made from cordierite materials comprising talc, kaolin, alumina, etc. of which 10% by weight of the Al source is substituted with tungsten oxide having a different value of valence, the material being mixed with a binder and formed into honeycomb structure which was then dried (90° C., 6 hours) before being sintered at 1300° C. or higher temperature for two to five hours thereby forming the defects that would make the pores. Pt and RH were deposited as the catalyst on the carriers so as to support the predetermined quantity of catalyst (1.5 g/L). An ethanol solution of chloroplatinate and rhodium chloride was used as the catalyst solution. The ceramic carriers were immersed in the solution and were subjected to heat treatment at a temperature of 800° C. for two hours in air atmosphere, thereby completing the catalyst.

The 50% conversion temperature plotted along the ordinate in FIG. 1 can be used as an index for evaluating the conversion performance, and was determined as follows. A model gas including HC (hydrocarbon) was introduced into samples (measuring φ415 ×L 10 mm) of the ceramic catalyst to be evaluated for the conversion performance. While gradually raising the sample temperature, the temperature at which the HC conversion ratio calculated by the following formula was equal to 50% was determined and taken as the 50% conversion temperature.

HC conversion ratio=[Incoming HC concentration-Outgoing HC concentration]/[Incoming HC concentration]×100

The porosity was measured by the mercury porosimetry.

As shown in FIG. 1, 50% conversion temperature is 300° C. or lower when the porosity is 10% or higher, 180° C. or lower when the porosity is 30% or higher and 160° C. or lower when the porosity is 40% or higher. As described above, a higher catalyst performance can be achieved, when the porosity is increased, which causes the 50% conversion temperature to fall.

Besides controlling the void ratio, the conversion performance can be improved also by increasing the density of cells to obtain a larger surface area. Specifically, it is desired to set the density of cells to 50/in² or higher, preferably 100/in² or higher, more preferably 400/in² or higher, and further more preferably 900/in² or higher. A higher density of cells causes the surface area to increase resulting in a larger area whereon the catalyst can be supported. That is, since the quantity of catalyst supported on the carrier can be increased while the catalyst particle size and the distance between the catalyst particles remain constant, conversion performance is improved. In case the quantity of catalyst is kept constant, the distance between the catalyst particles can be made larger and deterioration due to coagulation of the catalyst can be prevented.

FIG. 2 shows the result of measuring the density of cells formed in the ceramic carrier and the conversion performance (50% conversion temperature) after deterioration test. The ceramic carriers were made similarly to the case shown in FIG. 1, and the desired density of cells was obtained by changing the die used in extruding. The catalyst was also deposited similarly, using the ethanol solution of chloroplatinate and rhodium chloride, to support the predetermined quantity of catalyst (1.5 g/L). The ceramic carriers were subjected to heat treatment at a temperature of 800° C. for two hours in air atmosphere, thereby completing the catalyst.

As shown in FIG. 2, when the density of cells was 100/in² or higher, the 50% conversion temperature is 400° C. or lower which is nearly equal to or lower than the spontaneous ignition temperature of C₃H₆, thus demonstrating the conversion performance. The 50% conversion temperature is 300° C. or lower when the density of cells was 400/in² or higher, and is 220° C. or lower when the density of cells to 900/in² or higher. Thus it is understood that 50% conversion temperature becomes lower as the density of cells increases, thereby improving the conversion performance.

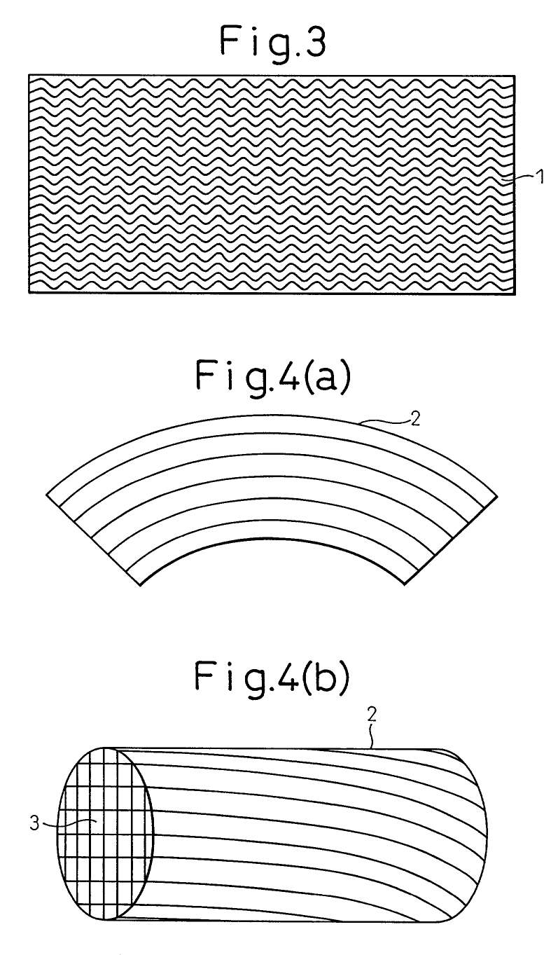

When the density of cells remains the same and, for example, in case the entire surface of the cell wall is corrugated in a direction perpendicular to the direction of extrusion as shown in FIG. 3, a larger surface area is obtained. There is also such an advantage that the probability of making contact with the catalyst increases since the stream of exhaust gas is disturbed by the surface irregularity. The pitch of the corrugated surface is typically set to be not larger than the carrier length. Preferably the pitch of the corrugated surface is 20 mm or less, and more preferably 5 mm or less. Amplitude of the corrugation is set to ½ of the cell pitch or less, and preferably in a range from ⅓ to ½ of the cell pitch. The corrugated surface may be formed by, for example, controlling the forming speed or other factor of the honeycomb forming process. Similar effect can be achieved by a method other than the regular configuration of the corrugated surface, such as roughening the surface by surface treatment as long as the cell wall 1 has surface irregularities.

The stream of exhaust gas can also be disturbed by forming non-straight gas flow passage in the cells. Specifically, when the ceramic carrier 2 is bent as a whole so that the direction of extrusion is curved in an arc shape as shown in FIG. 4(a), the gas flow passage is curved thus making the incoming exhaust gas flow more likely to be turbulent. At this time, the radius of curvature of the carrier 2 is set to 100 m or smaller. Preferably the radius of curvature of the carrier is set to 10 m or smaller, and more preferably in a range from 200 to 500 mm.

Alternatively, the carrier 2 may have the normal cylindrical profile with the multitude of cells formed therein being warped in the direction of flow. For example, a curved gas flow passage can be made similarly to the above when the cells 3 are formed to turn in spiral around the direction of extrusion as shown in FIG. 4(b). This also increases the probability of contact with the catalyst thereby improving the conversion performance. Specifically, the spiral is designed to turn 0.1 degrees or more per 1 m along the flow passage. Preferably, the spiral is designed to make one full turn or more per 1 m along the flow passage, and more preferably two to four turns per 1 m along the flow passage.

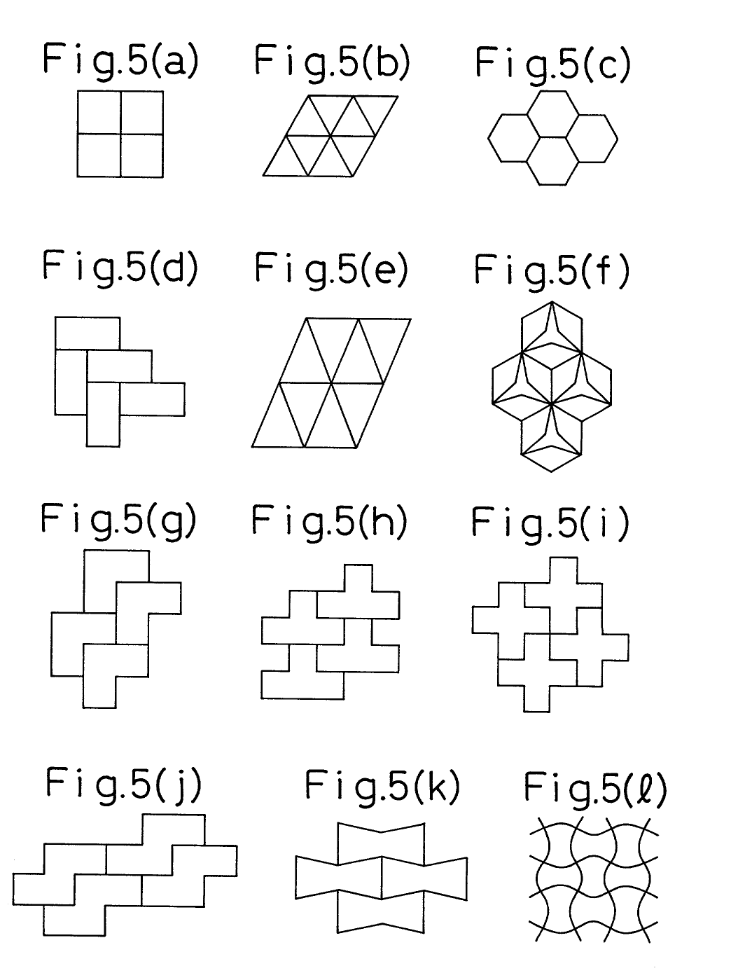

Given the same cross sectional area, the surface area of the cell wall increases as the cross sectional shape of the cell departs from circle. Thus the surface area can be increased by forming the cell having a cross section other than circle or combining various shapes. Specifically, such shapes as polygonal shapes such as square, equilateral triangle, equilateral hexagon, rectangle or isosceles triangle as shown in FIGS. 5(a) to (e), a shape of equilateral hexagon including other shape formed therein as shown in FIG. 5(f), L-shape (FIG. 5(g)), convex (FIG. 5(h)), cross (FIG. 5(i)), S-shaped (FIG. 5(j)) or dumbbell (FIGS. 5(k), (1)) may be used. A complicated shape of the cell cross section also causes more disturbance in the gas flow, thereby improving the conversion performance.

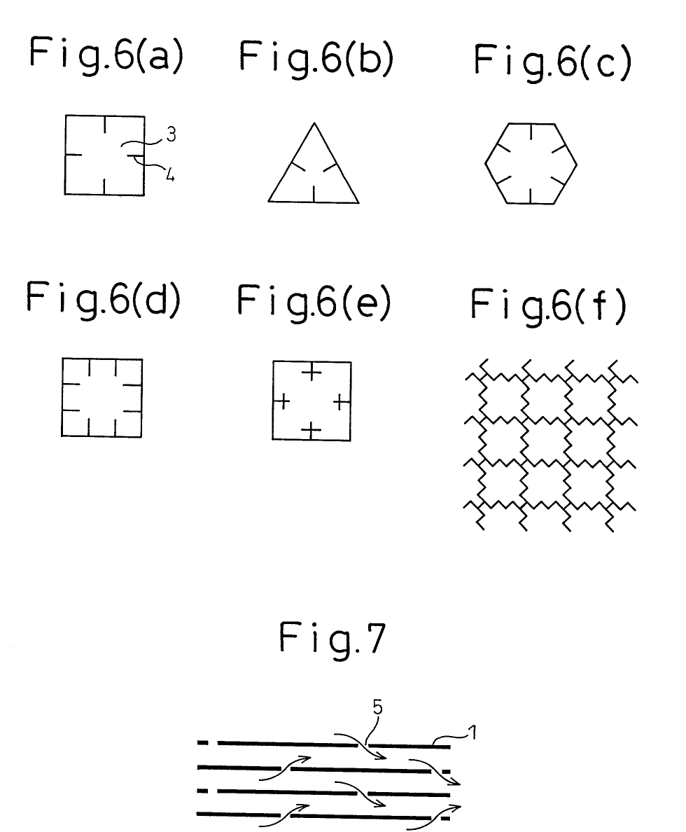

For the cell shapes described above, a plurality of projections may also be formed so as to jut inward from the surface. For examples, FIGS. 6(a) to (c) show the cells 3 having square, equilateral triangle and equilateral hexagon shapes, respectively, having fins 4 protruding from the surfaces of the cells 3 into the flow, which disturb the gas flow. The catalyst performance can be improved by having the catalyst supported on the surfaces of the fins 4thereby increasing the catalyst supporting area. As shown in FIGS. 6(d) and (e), configurations may also be employed such as two or more fins 4being provided in each cell, or cross-shaped fin 4being provided. Further, as shown in FIG. 6(f), the cell wall 1 may also be formed in a jagged shape. At this time, the cross sectional area of the projection is typically set to be not larger than a half the area of cell opening. Preferably, cross sectional area of the projection is in a range from 1/20 to ⅓ of the area of the cell opening.

A multitude of through holes 5 may also be formed to penetrate the cell wall 1 as shown in FIG. 7. Providing the multitude of through holes 5 in the cell wall 1 causes the exhaust gas to flow from one cell 3 to the adjacent cell, thus causing more disturbance in the gas flow. This also causes the exhaust gas to stay longer in the carrier so as to have larger probability of making contact with the catalyst, thereby improving the conversion performance. The size of the through hole 5 in the direction of flow is typically not larger than five times the cell pitch. Preferably, length of the through hole 5 along the flow passage is not larger than the cell pitch. Width of the through hole 5 in the direction perpendicular to the flow passage is preferably smaller than the cell pitch.

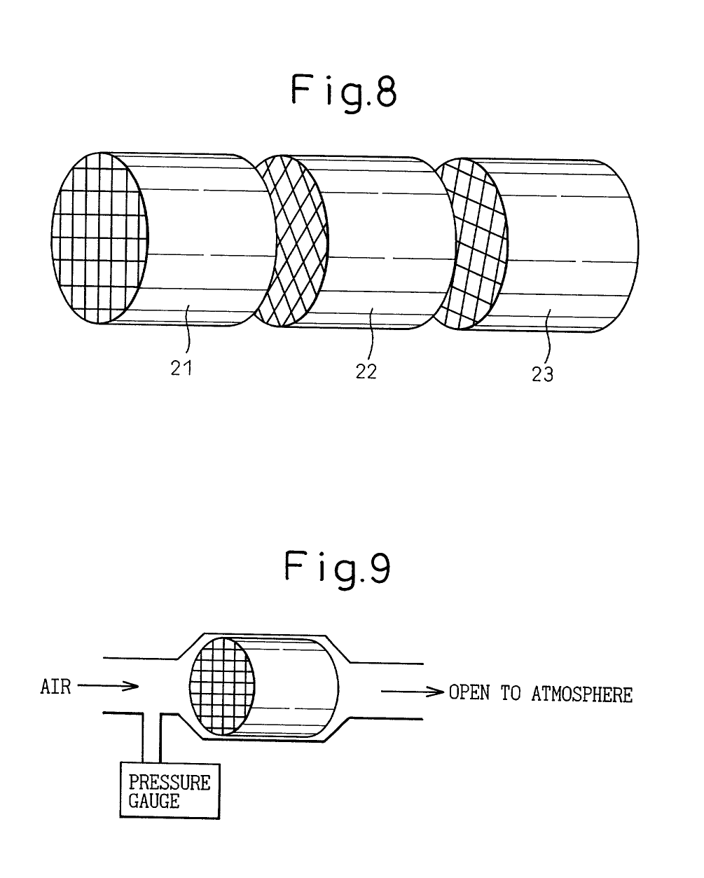

A constitution may also be employed where a plurality of ceramic carriers 21, 22, 23 are disposed in series in the direction of flow as shown in FIG. 8. At this time, the ceramic carrier 22 located in the downstream is turned, for example, by about 45° around the direction of extrusion relative to the ceramic carrier 21 located in the upstream, so that the cell wall 1 does not form a continuous plane in the joint. The ceramic carrier 22 and the ceramic carrier 23 are also arranged to have similar relation. With such a constitution as described above, since the wall surface of the flow passage formed in the cell 3 becomes discontinuous, the exhaust gas which has passed through the ceramic carrier 21 is disturbed when entering the ceramic carrier 22 located the downstream. Also, because a plurality of different flow passages communicate with each other, the exhaust gas flowing therethrough has higher probability of making contact with the catalyst, thus improving the conversion performance. Since the ceramic carrier which supports the catalyst directly on the surface does not require a coating layer and causes a lower pressure loss, no problem due to an increase in the pressure loss arises even when the plurality of ceramic carriers 21, 22, 23 are connected in series.

### EXAMPLES

Examples and Comparative Examples will be described below in order to verify the effects of the present invention.

(1) When the cell wall has corrugated surface (Examples 1 to 4, Comparative Examples 1, 2)

Cordierite materials comprising talc, kaolin, alumina, aluminum hydroxide, W0₃ of a quantity corresponding to 5% of the Si source and CoO of a quantity corresponding to 5% of the Si source were mixed, in the form of powder, in proportions around the theoretical composition of cordierite. Proper quantities of a binder, a lubricant, a humectant and water were added to the mixture and mixed to make a paste. The paste was formed into honeycomb structure having cell wall thickness of 100 μm, cell density of 400 cpsi (number of cells per 1 square inch), diameter of 103 mm and length of 130 mm by extruding (cell wall has flat surface). The honeycomb structure was sintered in an air atmosphere at 1390° C. (Comparative Example 1),

Using paste which was prepared similarly to Comparative Example 1, honeycomb preforms having cell walls of corrugated surfaces were made by inserting a plate on the material feeding side of the die for regulating the feeding rate when forming the honeycomb by injection molding. By controlling the feeding rate, various honeycomb preforms were formed with different values of pitch of corrugated surface (distance between adjacent troughs) and amplitude (height of peak) as shown in Table 1. These honeycomb preforms were dried and sintered by similar method (Examples 1 to 4, Comparative Example 2)

The cordierite honeycomb structures of Examples 1 to 4 and Comparative Examples 1 and 2 were immersed in ethanol solution including 0.035 mol/L of chloroplatinate and 0.025 mol/L of rhodium chloride for five minutes. Then after removing excess solution, the honeycombs were dried and sintered at 600° C. in air atmosphere to metalize. The cordierite honeycomb structures having the catalyst component supported thereon as described above (ceramic catalysts) were evaluated for the conversion performance thereof. The evaluation was conducted by measuring the 50% conversion temperature of C₃H₆ under the conditions of reaction gas composition [C₃H₆: 500 ppm, O₂: 5% O₂, N₂ balance] and flow velocity SV=10000 h⁻¹. Table 1 shows the pitch and amplitude of the corrugated surface of the cell wall of the cordierite honeycomb structures, 50% conversion temperature and pressure loss. The pressure loss was measured by inserting the cordierite honeycomb structures (103 mm in diameter, 130 mm in length) of Examples 1 to 4 and Comparative Examples 1 and 2 in measuring vessels and taking the pressure difference in the upstream of the honeycomb structure with respect to the atmosphere when air of 2000 L/min. was caused to flow.

TABLE 1
Characteristics if cell wall is corrugated

| | Pitch | Amplitude | 50% conversion | Pressure |
|---|---|---|---|---|
| | (mm) | (mm) | temperature (° C.) | loss (kPa) |
| Comparative | — | — | 235 | 0.34 |
| Example 1 | | | | |
| Example 1 | 50 | 0.3 | 227 | 0.36 |
| Example 2 | 10 | 0.3 | 220 | 0.37 |
| Example 3 | 2 | 0.3 | 215 | 0.39 |
| Example 4 | 2 | 0.5 | 201 | 0.49 |
| Comparative | 10 | 0.7 | 211 | 0.61 |
| Example 2 | | | | |

Cell pitch: 1.27 mm

As shown in Table 1, the 50% conversion temperature was lower in Examples 1 to 4 where the cell walls were formed with corrugated surfaces, in comparison to Comparative Example 1 where the cell walls were not formed with corrugated surfaces. It can also be seen that greater effect of lowering the 50% conversion temperature can be achieved as the pitch of the corrugated surface decreases. This is because the corrugated surface of the cell wall disturbs the gas flow so as to increase the probability of making contact with the catalyst, thus improving the conversion performance. The 50% conversion temperature can be lowered further by increasing the amplitude of the corrugated surface. However, when the amplitude of the corrugated surface becomes larger than one half the cell pitch (1.27 mm), the pressure loss becomes larger than that of the prior art case where the surface is coated with 200 g/L of γ-alumina (0.55 kPa), thus canceling the merit of low pressure loss (Comparative Example 2).

(2) When projection is formed on cell wall surface (Examples 5 to 7 and Comparative Example 3)

Cordierite materials comprising talc, kaolin, alumina, aluminum hydroxide, W0₃ of a quantity corresponding to 5% of the Si source and CoO of a quantity corresponding to 5% of the Si source were mixed, in the form of powder, in proportions around the theoretical composition of cordierite. Proper quantities of a binder, a lubricant, a humectant and water were added to the mixture and mixed to form a paste. The paste was formed into honeycomb structure having cell wall thickness of 100 μm, cell density of 400 cpsi, diameter of 103 mm and length of 130 mm having projections on the cell walls by extruding. The honeycomb structure was dried and then sintered in air atmosphere at 1390° C.

One projection was formed in each cell at the center of the cell wall toward the center of the cell. Cross sectional area of the projection was controlled as shown in Table 2 by using dies of different sizes when forming the honeycomb by injection molding (Examples 5 to 7 and Comparative Example 3). A catalyst component was deposited on the cordierite honeycomb structures of Examples 5 to 7 and Comparative Example 3 by similar method to Example 1. Conversion performance and pressure loss measured on these catalysts are shown in Table 2. Table 2: Characteristics when projection is formed on cell wall

TABLE 2
Characteristics when projection is formed on cell wall

| | Cross sectional | | |
|---|---|---|---|
| | area of | 50% conversion | Pressure |
| | projection (mm²) | temperature (° C.) | loss (kPa) |
| Example 5 | 0.05 | 221 | 0.38 |
| Example 6 | 0.10 | 213 | 0.47 |
| Example 7 | 0.50 | 217 | 0.51 |
| Comparative | 0.70 | 219 | 0.60 |
| Example 3 | | | |

Opening area of cell: 1.37 mm²

As shown in Table 2, forming the projection makes the 50% conversion temperature lower than that of Comparative Example 1 which has no projection. The 50% conversion temperature becomes lower as the cross sectional area of the projection is increased. Specifically, the 50% conversion temperature becomes lowest when the cross sectional area of the projection is in a range from 1/20 to ⅓ of the area of the cell opening (1.37 mm₂), and becomes a little higher when the cross sectional area is increased further. When the cross sectional area of the projection is larger than half the area of the cell opening, the pressure loss becomes larger than that of the prior art case where the surface is coated with 200 g/L of γ-alumina (0.55 kPa), thus canceling the merit of low pressure loss (Comparative Example 3).

(3) When a gas flow passage is warped (Examples 8 to 10 and Comparative Example 4)

Cordierite materials comprising talc, kaolin, alumina, aluminum hydroxide, W0₃ of a quantity corresponding to 5% of the Si source and CoO of a quantity corresponding to 5% of the Si source were mixed, in the form of powder, in proportions around the theoretical composition of cordierite. Proper quantities of a binder, a lubricant, a humectant and water were added to the mixture and mixed to form a paste. The paste was formed into honeycomb structure having cell wall thickness of 100 μm, cell density of 400 cpsi, diameter of 103 mm and length of 130 mm with warped gas flow passage formed in the cells by extruding. Honeycomb preforms were made by inserting a plate on the material feeding side of the die for regulating the feeding rate when forming the honeycomb thereby controlling the radius of curvature of the honeycomb preform (Examples 8 to 10 and Comparative Example 4). The honeycomb structures made as described above were dried and then sintered in air atmosphere at 1390° C.

A catalyst component was deposited on the cordierite honeycomb structures of Examples 8 to 10 and Comparative Example 4 by similar method to Example 1. The conversion performance and pressure loss measured for these catalysts are shown in Table 3.

TABLE 3
Characteristics when flow passage is warped

| | Radius of | 50% conversion | Pressure loss |
|---|---|---|---|
| | curvature | temperature(° C.) | (kPa) |
| Example 8 | 12 m | 230 | 0.36 |
| Example 9 | 1 m | 226 | 0.38 |
| Example 10 | 300 mm | 210 | 0.50 |
| Comparative | 150 mm | 208 | 0.59 |
| Example 4 | | | |

As shown in Table 3, forming the warped gas flow passage makes the 50% conversion temperature lower than that of Comparative Example 1 which has straight gas flow passage, thus improving the conversion performance. The 50% conversion temperature becomes lower as the radius curvature of the cordierite honeycomb structure decreases, although the pressure loss tends to increase at this time. When the radius curvature becomes smaller than 200 mm, the pressure loss becomes larger than that of the prior art case where the surface is coated with 200 g/L of γ-alumina (0.55 kPa), thus canceling the merit of low pressure loss (Comparative Example 4).

(4) When gas flow passage is formed as a spiral (Examples 11 to 13 and Comparative Example 5)

Cordierite materials comprising talc, kaolin, alumina, aluminum hydroxide, W0₃ of a quantity corresponding to 5% of the Si source and CoO of a quantity corresponding to 5% of the Si source were mixed, in the form of powder, in proportions around the theoretical composition of cordierite. Proper quantities of a binder, a lubricant, a humectant and water were added to the mixture and mixed to make a paste. The paste was formed into honeycomb structure having cell wall thickness of 100 μm, cell density of 400 cpsi, diameter of 103 mm and length of 130 mm with the gas flow passage formed in a spiral shape by extruding. Honeycomb preforms were made by turning a base whereon the honeycomb preform was placed thereby controlling the rotation of the gas flow passage (Examples 11 to 13 and Comparative Example 5). The honeycomb structures made as described above were dried and then sintered in an air atmosphere at 1390° C.

Catalyst component was deposited on the cordierite honeycomb structures of Examples 11 to 13 and Comparative Example 5 by a method similar to Example 1. Conversion performance and pressure loss measured on these catalysts are shown in Table 4.

TABLE 4
Characteristics when flow passage is formed in spiral shape

| | Amount of | 50% conversion | Pressure loss |
|---|---|---|---|
| | rotation | temperature (° C.) | (kPa) |
| Example 11 | 0.20° | 231 | 0.35 |
| Example 12 | 1 turn | 224 | 0.40 |
| Example 13 | 3 turns | 209 | 0.51 |
| Comparative | 4.5 turns | 207 | 0.63 |
| Example 5 | | | |

As shown in Table 4, forming the gas flow passage in the spiral configuration makes the 50% conversion temperature lower than that of Comparative Example 1 which has straight gas flow passage, thus improving the conversion performance. The 50% conversion temperature becomes lower as the angle of deflection (the amount of rotation) per 1 m of the cordierite honeycomb structures along the direction of gas flow increases, although the pressure loss tends to increase at the same time. When the amount of rotation exceeds four turns per 1 m, pressure loss becomes larger than that of the prior art case where the surface is coated with 200 g/L of γ-alumina (0.55 kPa), thus canceling the merit of low pressure loss (Comparative Example 5).

(5) When through holes are formed in the cell walls (Examples 14 to 16 and Comparative Example 6)

Cordierite materials comprising talc, kaolin, alumina, aluminum hydroxide, W0₃ of a quantity corresponding to 5% of the Si source and CoO of a quantity corresponding to 5% of the Si source were mixed, in the form of powder, in proportions around the theoretical composition of cordierite. Proper quantities of a binder, a lubricant, a humectant and water were added to the mixture and mixed to make a paste. The paste was formed into honeycomb structure having cell wall thickness of 100 μm, cell density of 400 cpsi, diameter of 103 mm and length of 130 mm with through holes of different lengths being formed in the cell wall, by extruding. Through holes were formed by inserting a plate on the material feeding side of the die for regulating the paste feeding rate when forming the honeycomb structure, thereby forming the through holes of different lengths in the cell walls (Examples 14 to 16 and Comparative Example 6). The honeycomb preforms made as described above were dried and then sintered in an air atmosphere at 1390° C.

Catalyst component was deposited on the cordierite honeycomb structures of Examples 14 to 16 and Comparative Example 6 by a method similar to that of Example 1. Conversion performance, pressure loss and A-axis strength measured on these catalysts are shown in Table 5. The A-axis strength was determined by measuring the rupture strength of test samples 1 inch in diameter and 1 inch long made by cutting the cordierite honeycomb structures along the direction of flow passage and applying compressive force to the sample in the direction of flow passage.

TABLE 5
Characteristics when through holes are formed in cell wall

| | Length of through | 50% conversion | A-axis |
|---|---|---|---|
| | hole (mm) | temperature (° C.) | strength (MPa) |
| Example 14 | 0.6 | 218 | 13.2 |
| Example 15 | 1.0 | 214 | 12.6 |
| Example 16 | 6.0 | 228 | 10.6 |
| Comparative | 7.0 | 231 | 9.7 |
| Example 6 | | | |

As shown in Table 5, forming the holes through the cell wall makes the 50% conversion temperature lower than that of Comparative Example 1 which has no straight hole. When the through holes are too long, 50% conversion temperature becomes lower although the conversion performance decreases. From Table 5, it can be seen that best conversion performance can be achieved when length of the through holes is from 0.1 to 1 times the cell pitch (1.27 mm). When the length of the through holes is larger than 5 times the cell pitch (1.27 mm), A-axis strength becomes lower than the strength (10 MPa) required when assembling the honeycomb structure in the catalyst converter (Comparative Example 6).

What is claimed is:

1. A ceramic carrier capable of supporting a catalyst component directly on the surface of a substrate ceramic provided with a multitude of cells which are substantially parallel to each other with the inside thereof serving as gas flow passage, wherein said cell wall has irregular surface.

2. The ceramic carrier according to claim 1, wherein said cell wall surface is corrugated or roughened.

3. The ceramic carrier according to claim 2, wherein said corrugated surface has a pitch which is not larger than the length of the carrier.

4. The ceramic carrier according to claim 2, wherein the pitch of said corrugated surface is 20 mm or less.

5. The ceramic carrier according to claim 2, wherein the pitch of said corrugated surface is 5 mm or less.

6. The ceramic carrier according to claim 2, wherein amplitude of said corrugated surface is ½ of the cell pitch or smaller.

7. The ceramic carrier according to claim 2, wherein amplitude of said corrugated surface is in a range from ⅓ to ½ of the cell pitch.

8. The ceramic carrier according to claim 1, wherein a plurality of projections are provided which protrude inward from said cell wall surface.

9. The ceramic carrier according to claim 8, wherein cross sectional area of said projection is ½ of the opening area of the cell or smaller.

10. The ceramic carrier according to claim 8, wherein cross sectional area of said projection is in a range from 1/20 to ⅓ of the opening area of the cell.

11. A ceramic carrier capable of supporting a catalyst component directly on the surface of a substrate ceramic provided with a multitude of cells which are substantially parallel to each other with the inside thereof serving as gas flow passage, wherein said gas flow passage is not straight.

12. The ceramic carrier according to claim 11, wherein said multitude of cells are warped in the direction of flow.

13. The ceramic carrier according to claim 11, wherein said carrier has radius of curvature not larger than 100 m.

14. The ceramic carrier according to claim 11, wherein said carrier has radius of curvature not larger than 10 m.

15. The ceramic carrier according to claim 11, wherein said carrier has radius of curvature which is in a range from 200 to 500 mm.

16. The ceramic carrier according to claim 11, wherein said multitude of cells are curved in spiral in the direction of flow.

17. The ceramic carrier according to claim 11, wherein the gas flow passage rotates by 0.1 degrees or more per 1 m of said carrier.

18. The ceramic carrier according to claim 11, wherein the gas flow passage rotates by one turn or more per 1 m of said carrier.

19. The ceramic carrier according to claim 11, wherein the gas flow passage rotates by two to four turns per 1 m of said carrier.

20. A ceramic carrier capable of supporting a catalyst component directly on the surface of a substrate ceramic provided with a multitude of cells which are substantially parallel to each other with the inside thereof serving as gas flow passage, wherein said cells have cross section in a shape of polygon, L-shaped, convex, cross, S-shaped, dumbbell configuration or a combined shape thereof.

21. A ceramic carrier capable of supporting a catalyst component directly on the surface of a substrate ceramic provided with a multitude of cells which are substantially parallel to each other with the inside thereof serving as gas flow passage, wherein the multitude of cell have a multitude of through holes formed in the cell wall.

22. The ceramic carrier according to claim 21, wherein length of said through hole in the direction of flow is five times the cell pitch or smaller.

23. The ceramic carrier according to claim 21, wherein length of said through hole in the direction of flow is not larger than the cell pitch.

24. The ceramic carrier according to claim 21, wherein width of said through hole in the direction perpendicular to the flow passage is smaller than the cell pitch.

25. A ceramic carrier capable of supporting a catalyst component directly on the surface of a substrate ceramic wherein a porosity of said substrate ceramic is 5% or higher.

26. The ceramic carrier according to claim 25, wherein the porosity of said substrate ceramic is 10% or higher.

27. The ceramic carrier according to claim 25, wherein the porosity of said substrate ceramic is 30% or higher.

28. A ceramic carrier capable of supporting a catalyst component directly on the surface of a substrate ceramic provided with a multitude of cells which are substantially parallel to each other with the inside thereof serving as gas flow passage, wherein density of the cells is 50/in² or higher.

29. The ceramic carrier according to claim 28, wherein said density of the cells is 100/in² or higher.

30. The ceramic carrier according to claim 28, wherein said density of the cells is 400/in² or higher.

31. A ceramic carrier which has a multitude of cells disposed substantially parallel to each other with the inside thereof serving as gas flow passage, wherein a plurality of ceramic carriers capable of supporting a catalyst component directly on the surface of substrate ceramic are disposed in series in the direction of gas flow, and the cell walls of said plurality of ceramic carriers are disposed so as to be discontinuous at the joint.

32. The ceramic carrier according to claim 1, wherein one or more constituent element of the substrate ceramic is substituted with an element other than the constituent element, and the carrier is made capable of supporting the catalyst component directly on the substituting element.

33. The ceramic carrier according to claim 32, wherein said catalyst component is supported on the substituting element by a chemical bond.

34. The ceramic carrier according to claim 32, wherein said substituting element is one or more element having d or f orbits in the electron orbits thereof.

35. The ceramic carrier according to claim 1, which has a multitude of pores capable of supporting the catalyst component directly on the surface of the substrate ceramic, wherein the catalyst component can be supported directly in the pores.

36. The ceramic carrier according to claim 35, wherein said pores comprise at least one kind selected from among a group consisting of defects in the ceramic crystal lattice, microscopic cracks in the ceramic surface and missing defects of the elements which constitute the ceramic.

37. The ceramic carrier according to claim 36, wherein width of said microscopic cracks is 100 nm or less.

38. The ceramic carrier according to claim 36, wherein said pores have diameter or width 1000 times the diameter of the catalyst ion to be supported or smaller, and the density of said pores is 1×10¹¹/L or higher.

39. The ceramic carrier according to claim 36, wherein said substrate ceramic includes cordierite as the main component, and said pores comprise defects formed by substituting a part of the constituent elements of the cordierite with metal element having different value of valence.

40. The ceramic catalyst body according to claim 39, wherein said defects comprise at least one kind, an oxygen defect or a lattice defect, and the density of cordierite crystal which includes at least one defect in a unit crystal lattice of cordierite is set to 4×10⁻⁶ % or higher.

41. A ceramic catalyst body which is constituted from the ceramic carrier of claim 1 and has a catalyst component supported directly thereon without forming a coating layer.
